(19) United States
(12) Patent Application Publication
(10) Pub. No.: US 2016/0235057 A1
(43) Pub. Date: Aug. 18, 2016

(54) Compositions, Wipes, and Methods

(71) Applicant: 3M INNOVATIVE PROPERTIES COMPANY, Saint Paul, MN (US)

(72) Inventors: Zai-Ming Qiu, Woodbury, MN (US); Yifan Zhang, Woodbury, MN (US); Liming Song, Woodbury, MN (US)

(21) Appl. No.: 15/024,332

(22) PCT Filed: Sep. 23, 2014
(86) PCT No.: PCT/US2014/056906

§ 371 Date: Mar. 23, 2016

Related U.S. Application Data
(60) Provisional application No. 61/884,305, filed on Sep. 30, 2013.

(51) Int. Cl. A01N 25/10; C11D 17/04; D04H 3/011; A01N 25/34

(52) U.S. Cl. CPC A01N 25/10; A01N 25/34; C11D 17/049; D04H 3/011

(57) ABSTRACT

A composition of matter that includes: an aliphatic polyester; at least 2 wt-% of an unreacted epoxidized fatty ester, wherein the epoxidized fatty ester has greater than 4.7 wt-% oxirane oxygen, based on the total weight of the epoxidized fatty ester; and greater than 0 and up to 10 wt-% of a shrink reduction additive; wherein the aliphatic polyester, epoxidized fatty ester, and shrink reduction additive form a mixture; and wherein the weight percentages, other than the weight percentage of the oxirane oxygen, are based on the total weight of the mixture.

### BACKGROUND

There is a trend to manufacture products from renewable resources for global environmental protection. Aliphatic polyesters from renewable resources have found increasing application in materials because of their biodegradability and compostability, such as poly(lactic acid); however, such materials may not have suitable shelf-life stability for certain applications, particularly in environments of high moisture content due to degradation from hydrolysis. For extended hydrolytic stability of these aliphatic polyesters, reactive additives are commonly used to crosslink terminal —OH and/or —CO₂H groups as one of the approaches. This may significantly change the molecular weight of the original aliphatic polyester, which may affect its processability and properties. Thus, there is a need for hydrolytic stabilization of aliphatic polyesters without reaction between the stabilizer and the aliphatic polyesters.

### SUMMARY OF THE DISCLOSURE

The present disclosure provides compositions of matter for use in making films, fibers, molded items, etc., and methods of using and making the compositions and wipes. In particular, the fibers can be used for making wipes such as wet wipes for cleaning and/or disinfecting (e.g., antimicrobial wipes). The compositions of matter include aliphatic polyesters and two or more additives that improve the hydrolytic stability of the composition and reduce the shrinkage of a web made from the material.

In one embodiment, there is provided a composition of matter that includes: an aliphatic polyester; at least 2 wt-% of an unreacted epoxidized fatty ester, wherein the epoxidized fatty ester has greater than 4.7 wt-% oxirane oxygen, based on the total weight of the epoxidized fatty ester; and greater than 0 and up to 10 wt-% of a shrink reduction additive; wherein the aliphatic polyester, epoxidized fatty ester, and shrink reduction additive form a mixture; and wherein the weight percentages, other than the weight percentage of the oxirane oxygen, are based on the total weight of the mixture (i.e., the aliphatic polyester, epoxidized fatty ester, shrink reduction additive, and optional additives).

In certain embodiments, the aliphatic polyester is selected from the group of poly(lactide), poly(glycolide), poly(lactide-co-glycolide), poly(L-lactide-co-trimethylene carbonate), poly(dioxanone), poly(butylene succinate), poly(butylene adipate), poly(ethylene adipate), polyhydroxybutyrate, polyhydroxyvalerate, and blends and copolymers thereof.

The composition of matter can be in the form of a film or fibers, wherein the fibers can form a fibrous web, such as a nonwoven web.

In another embodiment, the present disclosure provides a wet wipe that includes: a web of fibers (i.e., a fibrous web) as described herein; and an aqueous composition in contact with the web of fibers, wherein the aqueous composition includes water and a surfactant and/or a biocide (dissolved or dispersed in the water). The aqueous composition may also include one or more organic solvents, such as alcohols (e.g., isopropanol), along with the water.

In yet another embodiment, the present disclosure provides a wet wipe that includes: a fibrous web including fibers that include: an aliphatic polyester; at least 2 wt-% of an unreacted epoxidized fatty ester, wherein the epoxidized fatty ester has greater than 4.7 wt-% oxirane oxygen, based on the total weight of the epoxidized fatty ester; and greater than 0 and up to 10 wt-% of a shrink reduction additive; wherein the aliphatic polyester, epoxidized fatty ester, and shrink reduction additive form a mixture; and wherein the weight percentages, other than the weight percentage of the oxirane oxygen, are based on the total weight of the mixture; and an aqueous composition in contact with the fibrous web, wherein the aqueous composition includes: water; and a surfactant and/or a biocide (dissolved or dispersed in the water).

In certain embodiments, the aqueous composition includes a surfactant, wherein the wet wipe is a cleaning wipe.

In certain embodiments, the aqueous composition includes a biocide, wherein the wet wipe is a disinfecting wipe.

In certain embodiments, the aqueous composition includes a biocide and a surfactant, wherein the wet wipe is a cleaning/disinfecting wipe.

In certain embodiments, the present disclosure provides a process for improving the hydrolytic stability of a composition of matter that includes an aliphatic polyester. The method including: mixing components that include an aliphatic polyester, an unreacted epoxidized fatty ester, and a shrink reduction additive; wherein the shrink reduction additive is present in an amount of greater than 0 and up to 10 wt-%; wherein the epoxidized fatty ester is present in an amount of at least 2 wt-%, and has at least 4.7 wt-% oxirane oxygen, based on the total weight of the epoxidized fatty ester; and wherein the weight percentages, other than the weight percentage of the oxirane oxygen, are based on the total weight of the mixture.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to claims of the disclosure that may afford certain benefits, under certain circumstances. However, other claims may also be preferred, under the same or other circumstances. Furthermore, the recitation of one or more preferred claims does not imply that other claims are not useful, and is not intended to exclude other claims from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the term “room temperature” refers to a temperature of about 20° C. to about 25° C. or about 22° C. to about 25° C.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION OF ILLUSTRATIVE EMBODIMENTS

The present disclosure provides compositions of matter for use in making articles such as films, beads, molded items, and fibers (e.g., fibers for use in making wipes such as wet wipes), and methods of making the compositions. The wet wipes can be used as cleaning or disinfecting wipes (e.g., antimicrobial wipes such as antiviral and/or antibacterial and/or antifungal wipes). Significantly, wet wipes of the present disclosure have advantageous shelf-life stability.

Compositions of matter of the present disclosure include an aliphatic polyester, an unreacted epoxidized fatty ester, and a shrink reduction additive. In certain embodiments, a composition (i.e., a composition of matter) of the present disclosure includes at least 2 wt-% of an unreacted epoxidized fatty ester, wherein the epoxidized fatty ester has greater than 4.7 wt-% oxirane oxygen, based on the total weight of the epoxidized fatty ester; and greater than 0 and up to 10 wt-% of a shrink reduction additive; wherein the weight percentages, other than the weight percentage of the oxirane oxygen, are based on the total weight of the mixture (i.e., the aliphatic polyester, epoxidized fatty ester, shrink reduction additive, and optional additives).

Such compositions of matter are in the form of mixtures, which can be a blend, a compounded mixture, or the like, wherein the unreacted epoxidized fatty ester is uniformly distributed or dispersed within the aliphatic polyester. That is, the unreacted epoxidized fatty ester and the aliphatic polyester are not noticeably reacted with each other such that chemical bonds are formed. That is, relative to the aliphatic polyester, the epoxidized fatty ester is “unreacted.”

Herein, an unreacted epoxidized fatty ester is one that does not noticeably react with the aliphatic polyester during normal thermal processing and does not noticeably increase the molecular weight of the aliphatic polyester or the corresponding viscosity of the mixture. In this context, an “unreacted” epoxidized fatty ester is one that remains in a “free” or unreacted state when in the mixture with the aliphatic polyester (even after thermal processing) in an amount of at least 80%, or at least 90%, or at least 95%, of the epoxidized fatty ester based on the analysis by Gel Permeation Chromatography (GPC) of the solution of the thermal processed mixture.

Thus, the present disclosure provides a process for improving the hydrolytic stability and reducing shrinkage of a composition of matter that includes an aliphatic polyester, wherein the method includes mixing components that include an aliphatic polyester, an unreacted epoxidized fatty ester, and a shrink reduction additive. In certain embodiments, the shrink reduction additive is present in an amount of greater than 0 and up to 10 wt-%; wherein the unreacted epoxidized fatty ester is present in an amount of at least 2 wt-% (or at least 5 wt-%), and has at least 4.7 wt-% oxirane oxygen, based on the total weight of the epoxidized fatty ester; and wherein the weight percentages, other than the weight percentage of the oxirane oxygen, are based on the total weight of the mixture (e.g., the aliphatic polyester, epoxidized fatty ester, shrink reduction additive, and optional additives). In forming such mixture, there is no noticeable reaction between the aliphatic polyester and the epoxidized fatty ester.

Compositions of matter of the present disclosure in the form of mixtures can be made into articles by compounding, co-extrusion, or solvent-based methods that can be used in making such articles. Articles made with the compositions of the present disclosure include molded polymeric articles, polymeric sheets, films, fibers, beads, porous membranes, polymeric foams, and the like.

In certain embodiments, the compositions of the present disclosure are used to form continuous fibers that form a web (i.e., a network of entangled fibers forming a sheet like or fabric like structure), particularly a nonwoven web (i.e., an assembly of polymeric fibers (oriented in one direction or in a random manner) held together by mechanical interlocking, fusing of thermoplastic fibers, bonding with a suitable binder such as a natural or synthetic polymeric resin, or a combination thereof).

The fibers can be made by various techniques, particularly melt-processing techniques. Exemplary fibers are melt-blown and spunbond fibers.

Webs made from the fibers can be woven, nonwoven, or knitted webs. The fibers can include fibers of indefinite length (e.g., filaments), fibers of discrete length (e.g., staple fibers), and multifilament yarns. Suitable manufacturing processes for making nonwoven webs include, but are not limited to, carding, meltblown, wet laid, air laid, or spunbond. The webs can be single layer or multi-layer constructions, such as SMS (Spunbond, Meltblown, Spunbond) or SMMS webs.

The general methods of making spunbond nonwoven fabric are well known in the art. An exemplary process of making spunbond nonwoven webs is described in U.S. Pat. No. 7,470,389 (Berrigan et al.). Generally, a stream of filaments is extruded from a spin-pack having multiple orifices arranged in a regular pattern and directed through a processing chamber. The stream of filaments are subsequently cooled and stretched with high speed air jets and deposited onto a collecting belt in a random manner. The collecting belt is generally porous. A vacuum device can be positioned below the collecting belt to assist the fiber deposition onto the collecting belt. The collected mass (web) can be imparted strength and integrity by thermal bonding (e.g., applying heated rolls or passing hot air through) to partially melt the polymer and fuse the fibers together. The web can be further bonded to improve strength and other properties by mechanical bonding processes such as hydroentangling as described, for example, in U.S. Pat. No. 4,808,467 (Israel et al.).

In certain embodiments, the fibers made using compositions of the present disclosure are fine fibers, wherein a population of such fibers has a median fiber diameter of no greater than 50 μm, or no greater than 25 μm, or no greater than 20 μm, or no greater than 10 μm, or no greater than 5 μm. In certain embodiments, the fibers are microfibers, wherein a population of such fibers has a median fiber diameter of at least one μm but no greater than 100 μm. In certain embodiments, the fibers are ultrafine microfibers, wherein a population of such fibers has a median fiber diameter of two μm or less. In certain embodiments, the fibers are sub-micrometer fibers, wherein a population of such fibers has a median fiber diameter of no greater than one μm.

The compositions of matter include an aliphatic polyester and additives such as an unreacted epoxidized fatty ester that improves the hydrolytic stability of the composition (and, hence, the “shelf life” of the composition), and a shrink reduction agent (e.g., one that improves the thermal process yield).

An improvement in the hydrolytic stability of a composition that includes an aliphatic polyester can be demonstrated by an improvement in the tensile strength and/or dimensional stability of the composition made into fibers forming a web, particularly after aging in an aqueous medium.

Typically, improvement in tensile strength means that a web made of fibers of the composition of the present disclosure demonstrates greater than 10% increase in tensile strength after aging at a temperature of 135° F. for at least 25 days (in an aqueous cleaning and/or disinfecting solution as exemplified in the Examples Section), compared to a web made of fibers of the same aliphatic polyester without such additives.

Typically, improvement in dimensional stability means that a web made of fibers of the composition of the present disclosure has at least one dimension which shrinks by no greater than 10% (preferably no greater than 5%) in the plane of the web when the web is heated to a temperature above a glass transition temperature of the fibers, but below the melting point of the fibers in an unrestrained (i.e., free to move) condition, as compared to a web made of fibers of the same aliphatic polyester made without such additives.

Such mixtures may demonstrate shrinkage problems, however, since epoxidized fatty esters, such as epoxidized vegetable oils, are well known as plasticizers that can significantly reduce the crystallinity of an aliphatic polyester. The addition of a shrinkage reduction additive thus provides a balance of properties by providing a reduction in shrinkage. Typically, reduction in shrinkage means a demonstration of greater than 5% decrease in shrinkage compared to a web made of fibers of the same aliphatic polyester and epoxidized fatty ester mixture made without such shrink reduction additive.

### Aliphatic Polyesters

Aliphatic polyesters useful in embodiments of the present disclosure include homo- and co-polymers of poly(hydroxyalkanoates), and homo- and co-polymers of those aliphatic polyesters derived from the reaction product of one or more polyols with one or more polycarboxylic acids that is typically formed from the reaction product of one or more alkanediols with one or more alkanedicarboxylic acids (or acyl derivatives). Aliphatic polyesters may further be derived from multifunctional polyols, e.g. glycerin, sorbitol, pentaerythritol, and combinations thereof, to form branched, star, and graft homo- and co-polymers.

Exemplary aliphatic polyesters are poly(lactic acid), poly(glycolic acid), poly(lactic-co-glycolic acid), polybutylene succinate, polyethylene adipate, polyhydroxybutyrate, polyhydroxyvalerate, blends, and copolymers thereof. One particularly useful class of aliphatic polyesters are poly(hydroxyalkanoates), derived by condensation or ring-opening polymerization of hydroxy acids, or derivatives thereof. Suitable poly(hydroxyalkanoates) may be represented by the Formula (I):

H(O—R—C(O)—)ₙOH (I)

wherein R is an alkylene moiety that may be linear or branched having 1 to 20 carbon atoms, preferably having 1 to 12 carbon atoms, more preferably having 1 to 6 carbon atoms; and n is a number such that the ester is polymeric, and is preferably a number such that the molecular weight of the aliphatic polyester is at least 8,000 daltons (Da).

In Formula (I), R may further include one or more catenary (i.e., in chain) ether oxygen atoms. That is, R may optionally be substituted by catenary (bonded to carbon atoms in a carbon chain) oxygen atoms. Generally, the R group of the hydroxy acid is such that the pendant hydroxyl group is a primary or secondary hydroxyl group.

Useful poly(hydroxyalkanoates) include, for example, homo- and copolymers of poly(3-hydroxybutyrate), poly(4-hydroxybutyrate), poly(3-hydroxyvalerate), poly(lactic acid) (as known as polylactide), poly(3-hydroxypropanoate), poly(4-hydroxypentanoate), poly(3-hydroxypentanoate), poly(3-hydroxyhexanoate), poly(3-hydroxyheptanoate), poly(3-hydroxyoctanoate), polydioxanone, polycaprolactone, and polyglycolic acid (i.e., polyglycolide).

Copolymers of two or more of the above hydroxy acids may also be used, for example, poly(3-hydroxybutyrate-co-3-hydroxyvalerate), poly(lactate-co-3-hydroxypropanoate), poly(glycolide-co-dioxanone), and poly(lactic acid-co-glycolic acid).

Blends of two or more of the poly(hydroxyalkanoates) may also be used, as well as blends (miscible or immiscible) with one or more other polymers and/or copolymers.

Aliphatic polyesters useful in the disclosure may include homopolymers, random copolymers, block copolymers, star-branched random copolymers, star-branched block copolymers, dendritic copolymers, hyperbranched copolymers, graft copolymers, and combinations thereof.

Another useful class of aliphatic polyesters includes those aliphatic polyesters derived from the reaction product of one or more alkanediols with one or more alkanedicarboxylic acids (or acyl derivatives). Such polyesters have the general Formula (II):

HO(—C(O)—R″—C(O)—)ₙ-[OR′O—C(O)—R″—C(O)—O]ₘ.(R′O)ₙH (II)

wherein: R′ and R″ each represent an alkylene moiety that may be linear or branched having from 1 to 20 carbon atoms, preferably 1 to 12 carbon atoms; m is a number such that the ester is polymeric, and is preferably a number such that the molecular weight of the aliphatic polyester is at least 8,000 daltons (Da); and each n is independently 0 or 1.

In Formula (II), R′ and R″ may further include one or more catemary (i.e., in chain) ether oxygen atoms. Examples of aliphatic polyesters include those homo- and co-polymers derived from (a) one or more of the following diacids (or derivative thereof): succinic acid; adipic acid; 1,12 dicarboxydodecane; fumaric acid; glutartic acid; diglycolic acid; and maleic acid; and (b) one of more of the following diols: ethylene glycol; 30 polyethylene glycol; 1,2-propane diol; 1,3-propanediol; 1,2-propanediol; 1,2-butanediol; 1,3-butanediol; 1,4-butanediol; 2,3-butanediol; 1,6-hexanediol; 1,2-alkane diols having 5 to 12 carbon atoms; diethylene glycol; polyethylene glycols having a molecular weight of 300 to 10,000 daltons, preferably 400 to 8,000 daltons; propylene glycols having a molecular weight of 300 to 4000 daltons; block or random copolymers derived from ethylene oxide, propylene oxide, or butylene oxide; dipropylene glycol; and polypropylene glycol, and (c) optionally a small amount (i.e., 0.5-7.0 mole-%) of a polyol with a functionality greater than two such as glycerol, neopentyl glycol, and pentaerythritol. Such polymers may include polybutylene succinate homopolymer, polybutylene adipate homopolymer, polybutylene adipate-succinate copolymer, polyethylene succinate-adipate copolymer, polyethylene glycol succinate homopolymer and polyethylene adipate homopolymer.

Commercially available aliphatic polyesters include poly(lactide), poly(glycolide), poly(lactide-co-glycolide), poly(L-lactide-co-trimethylene carbonate), poly(dioxanone), poly(butylene succinate), and polybutylene adipate).

Preferred aliphatic polyesters include those derived from semicrystalline polylactic acid. Poly(lactic acid) or polylactide has lactic acid as its principle degradation product, which is commonly found in nature, is non-toxic and is widely used in the food, pharmaceutical and medical industries. The polymer may be prepared by ring-opening polymerization of the lactic acid dimer, lactide. Lactic acid is optically active and the dimer appears in four different forms: L,L-lactide, D,D-lactide, D,L-lactide (meso lactide) and a racemic mixture of L,L- and D,D-. By polymerizing these lactides as pure compounds or as blends, poly(lactide) polymers may be obtained having different stereochemistries and different physical properties, including crystallinity. The L,L- or D,D-lactide yields semicrystalline poly(lactide), while the poly(lactide) derived from the D,L-lactide is amorphous. The polylactide preferably has a high enantiomeric ratio to maximize the intrinsic crystallinity of the polymer. The degree of crystallinity of a poly(lactic acid) is based on the regularity of the polymer backbone and the ability to crystallize with other polymer chains. If relatively small amounts of one enantiomer (such as D-) is copolymerized with the opposite enantiomer (such as L-) the polymer chain becomes irregularly shaped, and becomes less crystalline. For these reasons, when crystallinity is favored, it is desirable to have a poly(lactic acid) that is at least 85% of one isomer, more preferably at least 90% of one isomer, or even more preferably at least 95% of one isomer in order to maximize the crystallinity. An approximately equimolar blend of D-polylactide and L-polylactide is also useful. This blend forms a unique crystal structure having a higher melting point (approximately 210° C.) than does either the D-poly(lactide) and L-poly(lactide) alone (approximately 160° C.), and has improved thermal stability, see H. Tsuji et al., Polymer, 40 (1999) 6699-6708.

Copolymers, including block and random copolymers, of poly(lactic acid) with other aliphatic polyesters may also be used. Useful co-monomers include glycolide, beta-propiolactone, tetramethylglycolide, beta-butyrolactone, gamma-butyrolactone, pivalolactone, 2-hydroxybutyric acid, alpha-hydroxyisobutyric acid, alpha-hydroxyvaleric acid, alpha-hydroxyisovaleric acid, alpha-hydroxycaproic acid, alpha-hydroxyethylbutyric acid, alpha-hydroxyisocaproic acid, alpha-hydroxy-betamethylvaleric acid, alpha-hydroxyoctanoic acid, alpha-hydroxydecanoic acid, alpha-hydroxymyristic acid, and alpha-hydroxystearic acid. Blends of poly(lactic acid) and one or more other aliphatic polyesters, or one or more other polymers may also be used. Examples of useful blends include poly(lactic acid) with a second polymer selected from poly(vinyl alcohol), polyethylene glycol, polysuccinate, polyethylene oxide, polycaprolactone and polyglycolide.

Poly(lactide)s may be prepared as described in U.S. Pat. No. 6,111,060 (Gruber, et al.), U.S. Pat. No. 5,997,568 (Liu), U.S. Pat. No. 4,744,365 (Kaplan et al.), U.S. Pat. No. 5,475,063 (Kaplan et al.), U.S. Pat. No. 6,143,863 (Gruber et al.), U.S. Pat. No. 6,093,792 (Gross et al.), U.S. Pat. No. 6,075,118 (Wang et al.), U.S. Pat. No. 5,952,433 (Wang et al.), U.S. Pat. No. 6,117,928 (Hiltunen et al.), U.S. Pat. No. 5,883,199 (McCarthy et al.), and International Publication Nos. WO 98/124951 (Tsai et al.), WO 00/112606 (Tsai et al.), WO 84/04311 (Lin), WO 99/50345 (Kolstad et al.), WO 99/06456 (Wang et al.), WO 94/07949 (Gruber et al.), WO 96/122330 (Randall et al.), and WO 98/50611 (Ryan et al.), for example. Reference may also be made to J. W. Leenslag et al., J. Appl. Polymer Science, vol. 29 (1984), pp 2829-2842, and H. R. Kricheldorf, Chemosphere, vol. 43 (2001) 49-54.

The molecular weight of the polymer should be chosen so that the polymer may be processed as a melt. By “melt-processable,” it is meant that the aliphatic polyesters are fluid or can be pumped or extruded at the temperatures used to process the articles (e.g., make the fine fibers), and do not degrade or gel at those temperatures to the extent that the physical properties are so poor as to be unusable for the intended application. Thus, many of the materials can be made into nonwovens using melt processes such as spun bond, blown microfiber, and the like. Certain embodiments also may be injection molded.

In certain embodiments, the molecular weight (number average) of suitable aliphatic polyesters is at least 8,000, or at least 10,000, or at least 30,000, or at least 50,000 daltons. Although higher molecular weight polymers generally yield films with better mechanical properties, for both melt processed and solvent cast polymers excessive viscosity is typically undesirable. The molecular weight of the aliphatic polyester is typically no greater than 1,000,000, preferably no greater than 500,000, and most preferably no greater than 300,000 daltons (Da), as measured by gel permeation chromatography (GPC).

For a poly(lactide), for example, the molecular weight may be from 8,000 to 1,000,000 daltons, and is preferably from 30,000 to 300,000 daltons (Da).

The aliphatic polyester may be blended with other polymers but typically is present in compositions of the present disclosure in an amount of at least 50 weight percent, or at least 60 weight percent, or at least 65 weight percent, or at least 80 weight percent (wt-%) of the compositions of the present disclosure.

### Epoxidized Fatty Esters

Epoxidized fatty esters, such as epoxidized vegetable oils, are commonly known as plasticizers for easy thermal processing of polymers (or processing aides). Suitable epoxidized fatty esters for use in fibers of the present disclosure are used as hydrolysis stabilizing agents. That is, suitable epoxidized fatty esters are those capable of improving the hydrolytic stability of fibers that include an aliphatic polyester, but without noticeable reaction with the aliphatic polyester during mixing, and even during thermal processing, such as compounding and extrusion processing. That is, there is no significant reaction that occurred between the epoxidized fatty ester and the aliphatic polyester such that there is a noticeable increase in the molecular weight of the aliphatic polyester and the corresponding viscosity of the mixture. Specifically, a mixture of an epoxidized fatty ester and an aliphatic polyester, particularly one that is thermally processed, includes at least 80%, or at least 90%, or at least 95%, of free (unreacted) epoxidized fatty ester (based on the GPC analysis).

Even though there is little or no reaction (e.g., crosslinking) between the aliphatic polyester and the epoxidized fatty ester, particularly during thermal processing, the presence of the free epoxidized fatty esters in the presence of the aliphatic polyester reduces the hydrolysis rate when the compounded aliphatic polyester is aged or dispersed into a water-based medium for a long period of time. This occurs typically by reducing the hydrolysis speed of the aliphatic polyester by the unreacted epoxidized fatty esters.

Compositions of the present disclosure typically include an epoxidized fatty ester that has greater than 4.7 wt-% oxirane oxygen, based on the total weight of the epoxidized fatty ester. In certain embodiments, the amount of oxirane oxygen is at least 5.5 wt-%, at least 6 wt-%, or at least 9 wt-%, oxirane oxygen, based on the total weight of the epoxidized fatty ester. In certain embodiments, the amount of oxirane oxygen is up to 23 wt-%, or up to 11 wt-%, oxirane oxygen, based on the total weight of the epoxidized fatty ester. In certain embodiments, the amount of oxirane oxygen is 6 wt-% to 11 wt-% oxirane oxygen, based on the total weight of the epoxidized fatty ester.

In certain embodiments, the epoxidized fatty ester is an epoxidized poly(fatty ester) (i.e., a di- or tri-ester or higher functional ester). In certain embodiments, the epoxidized vegetable oil includes a di-ester, tri-ester, or combinations thereof. In certain embodiments, the epoxidized vegetable oil includes a tri-ester or higher functional ester.

In certain embodiments, the epoxidized fatty ester is a triglyceride of an epoxidized polyunsaturated fatty acid. The epoxidized polyunsaturated fatty acid can be made from the epoxidation of a triglyceride of a polyunsaturated fatty acid, wherein the triglyceride of a polyunsaturated fatty acid can be made from the estification of glycerol and a polyunsaturated fatty acid. Preferrably, the polyunsaturated fatty acid has two or more unsaturated double bonds for higher amounts of oxirane oxygen resulting from an epoxidization process. In certain embodiments, the polyunsaturated fatty acid is selected from linoleic acid, linoelaidic acid, α-linolenic acid, arachidonic acid, eicosapentaenoic acid, docosahexaenoic acid, and combinations thereof. The chemical structures of such preferred polyunsaturated fatty acids are shown in the following table.

| Common name | Chemical structure |
|---|---|
| Linoleic acid | CH₃(CH₂)₄CH═CHCH₂CH═CH(CH₂)₇COOH (9E,9E) |
| Linoelaidic acid | CH₃(CH₂)₄CH═CHCH₂CH═CH(CH₂)₇COOH (9Z,9Z) |
| α-Linolenic acid | CH₃CH₂CH═CHCH₂CH═CHCH₂CH═CH(CH₂)₇COOH |
| Arachidonic acid | CH₃(CH₂)₄CH═CHCH₂CH═CHCH₂CH═CHCH₂CH═CH(CH₂)₃COOH |
| Eicosapentaenoic acid | CH₃CH₂CH═CHCH₂CH═CHCH₂CH═CHCH₂CH═CHCH₂CH═CH(CH₂)₃COOH |
| Docosahexaenoic acid | CH₃CH₂CH═CHCH₂CH═CHCH₂CH═CHCH₂CH═CHCH₂CH═CHCH₂CH═CH(CH₂)₂COOH |

In certain embodiments, the epoxidized fatty ester is an epoxidized vegetable oil. In certain embodiments, the epoxidized vegetable oil is selected from the group of epoxidized soybean oil, epoxidized cottonseed oil, epoxidized wheat germ oil, epoxidized soya oil, epoxidized corn oil, epoxidized sunflower oil, epoxidized safflower oil, epoxidized hemp oil, epoxidized linseed oil, and combinations thereof.

In certain embodiments, the vegetable oil used for preparation of the epoxidized vegetable oil has a polyunsaturated value of at least 50 grams per 100 grams total oil, preferably at least 60 grams per 100 grams total oil. The polyunsaturated value is the weight of the polyunsaturated oil in 100 grams of total oil (100 g of saturated oil+monounsaturated oil+polyunsaturated oil). The polyunsaturated values of various oils, useful for making epoxidized vegetable oils, are shown in the following table, which shows that examples of epoxidized vegetable oil having a polyunsaturated value of at least approximately 50 grams per 100 grams total oil include wheat germ sunflower oil, safflower oil, and hemp oil.

| | Saturated | Monounsaturated | Polyunsaturated |
|---|---|---|---|
| Oil | g/100 g | g/100 g | g/100 g |
| Cottonseed oil | 25.5 | 21.3 | 48.1 |
| Wheat germ oil | 18.8 | 15.9 | 60.7 |
| Soya oil | 14.5 | 23.2 | 56.5 |
| Corn oil | 12.7 | 24.7 | 57.8 |
| Sunflower oil | 11.9 | 20.2 | 63.0 |
| Safflower oil | 10.2 | 12.6 | 72.1 |
| Hemp oil | 10 | 15 | 75 |

In certain embodiments, compositions of the present disclosure (i.e., mixtures) typically include at least 2 wt-%, or at least 3 wt-%, or at least 5 wt-%, of an epoxidized fatty ester, based on the total weight of the mixture (i.e., the aliphatic polyester, epoxidized fatty ester, shrink reduction additive, and optional additives). In certain embodiments, compositions of the present disclosure (i.e., mixtures) typically include up to 20 wt-%, or up to 10 wt-%, of an epoxidized fatty ester, based on the total weight of the mixture. In certain embodiments, compositions of the present disclosure (i.e., mixtures) typically include up to 7 wt-% (and in some embodiments, less than 7 wt-%), or up to 6 wt-%, of an epoxidized fatty ester, based on the total weight of the mixture.

### Shrink Reduction Additives

The “shrink reduction” or “antishrink” or “antishrinkage” additive (i.e., agent) refers to a thermoplastic polymeric additive which, when added to the aliphatic polyester in a suitable amount during thermal process formation of a uniform fibrous web, results in a web having at least one dimension which shrinks by no greater than 10% in the plane of the web when the web is heated to a temperature above a glass transition temperature of the fibers, but below the melting point of the fibers in an unrestrained (free to move) state, when compared to a web made in the same way with the same components without the shrink reduction additive.

Preferred shrink reduction additives (i.e., shrink reduction agents) form a dispersed phase in the aliphatic polyester when the mixture is cooled to 23-25° C. Preferred shrink reduction additives are also semicrystalline thermoplastic polymers as determined by differential scanning calorimetry.

Potentially useful semicrystalline polymers include polyethylene, linear low density polyethylene, polypropylene, polyoxymethylene, poly(vinylidine fluoride), poly(methyl pentene), poly(ethylene-chlorotrifluoroethylene), poly(vinyl fluoride), poly(ethylene oxide) (PEO), poly(ethylene terephthalate), poly(butylene terephthalate), semicrystalline aliphatic polyesters including polycaprolactone (PCL), aliphatic polyamides such as nylon 6 and nylon 66, thermotropic liquid crystal polymers, and combinations thereof. Particularly preferred semicreystalline polymers include polypropylene, nylon 6, nylon 66, polycaprolactone, and poly(ethylene oxide).

The shrink reduction additives have been shown to dramatically reduce the shrinkage of PLA nonwovens. The molecular weight (MW) of these additives may affect the ability to promote shrinkage reduction. Preferably the MW is greater than about 10,000 daltons, preferably greater than 20,000 daltons, more preferably greater than 40,000 daltons and most preferably greater than 50,000 daltons.

Derivatives of the thermoplastic shrink reduction polymers also may be suitable. Preferred derivatives will likely retain some degree of crystallinity. For example, polymers with reactive end groups such as PCL and PEO can be reacted to form, for example, polyesters or polyurethanes, thus increasing the average molecular weight.

A highly preferred shrink reduction additive is a polyolefin, in particular a polypropylene. Polypropylene homo- and co-polymers useful in practicing embodiments of the present disclosure may be selected from polypropylene homopolymers, polypropylene copolymers, and blends thereof (collectively polypropylene polymers). The homopolymers may be atactic polypropylene, isotactic polypropylene, syndiotactic polypropylene and blends thereof. The copolymer can be a random copolymer, a statistical copolymer, a block copolymer, and blends thereof. In particular, the polymer blends described herein include impact copolymers, elastomers and plastomers, any of which may be physical blends or in situ blends with the polypropylene.

The polypropylene polymers can be made by any method known in the art such as by slurry, solution, gas phase or other suitable processes, and by using catalyst systems appropriate for the polymerization of polyolefins, such as Ziegler-Natta-type catalysts, metallocene-type catalysts, other appropriate catalyst systems or combinations thereof. In a preferred embodiment, the propylene polymers are made by the catalysts, activators and processes described in U.S. Pat. No. 6,342,566 (Burkhardt et al.); U.S. Pat. No. 6,384,142 (Burkhardt et al.); WO 03/040201 (Stevens et al.); WO 97/19991 (McAlpin et al.) and U.S. Pat. No. 5,741,563 (Mehta et al.). Likewise, the polypropylene polymers may be prepared by the process described in U.S. Pat. Nos. 6,342,566 and 6,384,142. Such catalysts are well known in the art, and are described in, for example, ZIEGLER CATALYSTS (Gerhard Fink, Rolf Mulhaupt and Hans H. Brintzinger, eds., Springer-Verlag 1995); Resconi et ai., Selectivity in Propene Polymerization with Metallocene Catalysts, 100 CHEM. REV. 20 1253-1345 (2000); and I, II METALLOCENE-BASED POLYOLEFINS (Wiley & Sons 2000).

Propylene polymers that are useful in practicing some embodiments of the present disclosure include those sold under the tradenames ACHIEVE and ESCORENE by Exxon-Mobil Chemical Company (Houston, Tex.), and various propylene (co)polymers sold by Total Petrochemicals (Houston, Tex.).

Presently preferred propylene homopolymers and copolymers useful in the present disclosure typically have: 1) a weight average molecular weight (Mw) of at least 30,000 Da, preferably at least 50,000 Da, more preferably at least 90,000 Da, as measured by gel permeation chromatography (GPC), and/or no more than 2,000,000 30 Da, preferably no more than 1,000,000 Da, more preferably no more than 500,000 Da, as measured by gel permeation chromatography (GPC); and/or 2) a polydispersity (defined as Mw/Mn, wherein Mn is the number average molecular weight determined by GPC) of 1, preferably 1.6, and more preferably 1.8, and/or no more than 40, preferably no more than 20, more preferably no more than 10, and even more preferably no more than 3; and/or 3) a melting temperature Tm (second melt) of at least 30° C., preferably at least 50° C., and more preferably at least 60° C. as measured by using differential scanning calorimetry (DSC), and/or no more than 200° C., preferably no more than 185° C., more preferably no more than 175° C., and even more preferably no more than 170° C. as measured by using differential scanning calorimetry (DSC); and/or a crystallinity of at least 5%, preferably at least 10%, more preferably at least 20% as measured using DSC, and/or no more than 80%, preferably no more than 70%, more preferably no more than 60% as measured using DSC; and/or 5) a glass transition temperature (Tg) of at least −40° C., preferably at least −10° C., more preferably at least −10° C., as measured by dynamic mechanical thermal analysis (DMTA), and/or no more than 20° C., preferably no more than 10° C., more preferably no more than 5° C., as measured by dynamic mechanical thermal analysis (DMTA); and/or 6) a heat of fusion (Rf) of 180 J/g or less, preferably 150 J/g or less, more preferably 120 J/g or less as measured by DSC and/or at least 20 J/g, more preferably at least 40 J/g as measured by DSC; and/or 7) a crystallization temperature (Tc) of at least 15° C., preferably at least 20° C., more preferably at least 25° C., even more preferably at least 60° C. and/or, no more than 120° C., preferably no more than 115° C., more preferably no more than 110° C., even more preferably no more than 145° C.

Compositions of the present disclosure (i.e., mixtures) include a shrink reduction additive (preferably a propylene polymer (including both poly(propylene) homopolymers and copolymers)) in an amount of greater than 0 and up to 10 wt-%, based on the total weight of the mixture. In certain embodiments, compositions of the present disclosure include a shrink reduction additive in an amount of at least 0.5 wt-%, or at least 1 wt-%, or at least 2 wt-%, based on the total weight of the mixture. Compositions of the present disclosure include a shrink reduction additive (preferably a propylene polymer (including both poly(propylene) homopolymers and copolymers)) in an amount of up to 5 wt-%, based on the total weight of the mixture.

### Optional Additives

Various optional additives may be added to the compositions of the present disclosure. Suitable additives include, but are not limited to, particulates, fillers, stabilizers, plasticizers, tackifiers, flow control agents, cure rate retarders, adhesion promoters (for example, silanes and titanates), adjuvants, impact modifiers, expandable microspheres, thermally conductive particles, electrically conductive particles, silica, glass, clay, talc, pigments, colorants, glass beads or bubbles, antioxidants, optical brighteners, antimicrobial agents, surfactants, wetting agents, fire retardants, and repellents such as hydrocarbon waxes, silicones, and fluorochemicals. However, some fillers (i.e., insoluble organic or inorganic materials generally added to augment weight, size or to fill space in the resin for example to decrease cost or impart other properties such as density, color, impart texture, effect degradation rate and the like) may detrimentally effect fiber properties.

Fillers, if used, can be particulate non-thermoplastic or thermoplastic materials. Fillers also may be non-aliphatic polyesters polymers which often are chosen due to low cost such as starch, lignin, and cellulose based polymers, natural rubber, and the like. These filler polymers tend to have little or no crystallinity.

Fillers, plasticizers, and other additives, when used at levels above 3% by weight, and more certainly above 5% by weight of the aliphatic polyester, can have a significant negative effect on physical properties such as tensile strength of a web of fibers of the composition of the present disclosure, for example. Above 10% by weight of the aliphatic polyester resin, these optional additives can have a dramatic negative effect on physical properties. Therefore, total optional additives are typically present at no more than 10% by weight, preferably no more than 5% by weight and most preferably no more than 3% by weight based on the weight of the aliphatic polyester.

### Wet Wipes

Compositions of the present disclosure can be used in making fibers for wipes, particularly wet wipes.

“Wet” wipe is a wipe wherein a substrate, typically a fibrous web (e.g., nonwoven web), has been pre-moistened with the aqueous composition. That is, the aqueous composition is in contact with the fibrous web. In most cases the wipe has been saturated with the aqueous composition (i.e., full absorbent capacity of the substrate used). But this may not necessarily have to be the case. It would depend on the absorbent capacity of the wipe and aqueous formulation. As long as the wipe can be loaded with enough active material, it would not have to be completely saturated. In some cases the wipes may be super saturated, i.e., have more liquid than its absorbent capacity. This is achieved, for example, by delivering the wipes from a container with excess liquid composition.

Wet wipes are typically sold in sealed single-use or resealable multi-use packages or canisters often with an excess of the aqueous composition. “Wet” wipe also includes a wipe that is coated with a concentrate up to 100% solids that is subsequently wet with water by the user. For example, a roll of perforated wipes can be provided in a container to which the user adds a predetermined amount of water that wicks into the roll of wipes. In certain embodiments, the aqueous composition is present in an amount of at least 2 times, or at least 4 times, the weight of the fibrous web. In certain embodiments, the aqueous composition is present in an amount of up to 6 times, the weight of the fibrous web.

Herein, a wet wipe includes: a fibrous web as described herein and an aqueous composition that includes water and a surfactant and/or a biocide (dissolved or dispersed in the water). The aqueous composition may also include one or more organic solvents, such as alcohols (e.g., isopropanol), along with the water. The aqueous composition is in contact with the fibrous web.

For example, in certain embodiments, a wet wipe of the present disclosure includes a fibrous web including fibers that include: an aliphatic polyester; at least 2 wt-% of an epoxidized fatty ester, wherein the epoxidized fatty ester has greater than 4.7 wt-% oxirane oxygen, based on the total weight of the epoxidized fatty ester; and greater than 0 and up to 10 wt-% of a polyolefin; wherein the aliphatic polyester, epoxidized fatty ester, and polyolefin form a mixture; and wherein the weight percentages, other than the weight percentage of the oxirane oxygen, are based on the total weight of the mixture (the aliphatic polyester, epoxidized fatty ester, polyolefin, and optional additives).

The wet wipe also includes an aqueous composition that includes water and a surfactant and/or a biocide. The aqueous composition can have a pH of 1 to 14. In certain embodiments, the aqueous composition includes at least 0.01 wt-%, or at least 0.05 wt-%, surfactant and/or biocide, based on the total weight of the aqueous composition. In certain embodiments, the aqueous composition includes up to 0.5 wt-%, surfactant and/or biocide, based on the total weight of the aqueous composition.

In certain embodiments, the aqueous composition includes a surfactant and the wet wipe is a cleaning wipe.

In certain embodiments, the aqueous composition includes a biocide and the wet wipe is a disinfecting wipe.

In certain embodiments, the aqueous composition includes a biocide and a surfactant, wherein the wet wipe is a cleaning/disinfecting wipe.

The surfactant can be nonionic, anionic, cationic, amphoteric (i.e., zwitterionic), or combinations thereof. In certain embodiments, the surfactant is a nonionic surfactant.

Exemplary anionic surfactants include alcohol sulfates and sulfonates, alcohol phosphates and phosphonates, alkyl sulfates, alkyl ether sulfate, sulfate esters of an alkylphenoxy polyoxyethylene ethanol, alkyl monoglyceride sulfate, alkyl sulfonate, alkyl benzene sulfonate, alkyl ether sulfonate, ethoxylated alkyl sulfonate, alkyl carboxylate, alkyl ether carboxylate, alkyl alkoxy carboxylate, alkane sulfonate, alkylbenzene sulfonate, alkyl ester sulfonate, alkyl sulfate, alkyl alkoxylated sulfate (e.g., sodium lauryl sulfate), alkyl carboxylate (e.g., sorbitan stearate), and sulfonated alkyl glucosides (e.g., sodium decylglucosides, hydroxypropyl sulfonate, sodium decylglucosides hydroxypropyl sulfonate and sodium laurylglucosides hydroxypropyl sulfonate).

Exemplary zwitteronic surfactants include Betaine and sultaine (e.g., C12-18 alkyl dimethyl betaines such as coconutbetaine), C10-C16 alkyl dimethyl betaine (laurylbetaine), fatty acylamidopropylene(hydroxylpropylene)sulfobetaine, lauryldimethylcarboxymethylbetaine, cocoamido propyl monosodium phosphitaine, cocoamido disodium 3-hydroxypropyl phosphobetaine, and amphoteric amine oxide (e.g., alkyl dimethyl amine oxides and alkylamidopropyl amine oxides).

Exemplary nonionic surfactants include ethoxylated alkylphenol, ethoxylated and propoxylated fatty alcohols, polyethylene glycol ethers of methyl glucose, ethoxylated esters of fatty acids, alkyl polyglucoside (e.g., capryl glucoside such as Glucopon 215UP, decyl glucoside such as Glucopon 225DK, coco-glucoside such as Glucopon 425N, lauryl glucoside such as Glucopon 625UP, an aqueous solution of alkyl glucosides based fatty acid alcohol C9-C11 such as APG 325N, and sodium laureth sulfate & lauryl glucoside & cocoamidopropyl betaine such as Plantapon 611L, fatty alcohol polyglycolether (e.g., Dephypon LS54, Dehypon LT104), fatty alcohol ethoxylates (propoxylates), and ethoxylated alkylphenol.

Exemplary cationic surfactants include aminoamide, quaternary ammonium salt, aminoamides (e.g., stearamidopropyl ethyldimonium ethosulfate, stearamidopropyl PG-dimonium chloride phosphate), and quaternary ammonium salts (e.g., cetyl ammonium chloride, lauryl ammonium chloride, and ditallow dimethyl ammonium chloride).

Various combinations of surfactants can be used if desired.

In certain embodiments, the biocide is a cationic biocide such as a quaternary ammonium salts (e.g., dodecyldimethyl benzyl ammonium chloride, tridecyldimethyl benzyl ammonium chloride, tetradecyldimethyl benzyl ammonium chloride, pentadecyldimethyl benzyl ammonium chloride, hexadecyldimethyl benzyl ammonium chloride, (butyl)(dodecyl)dimethyl ammonium chloride, (hexyl)(decyl)dimethyl ammonium chloride, dioctyldimethyl ammonium chloride), polyhexamethyl biguanide (PHMB), and chlorhexidine gluconate), aldehydes (e.g., formaldehyde, glutaraldehyde, parabens), phenolic biocides (e.g., those described in U.S. Pat. No. 6,113,933 (Beerse et al.), including thymol, tricosan, 0-penyl-phenol, p-chlorophenol, benzyl alcohol), essential oils (e.g., oils derived from herbs, flowers, trees, and other plants such as thyme, lemongrass, citrus, lemons, orange, anise, clove, lavender, cedar), metal salts (e.g., aluminum, silver, zinc, copper, and those described in U.S. Pat. No. 6,113,933), and antimicrobial lipids such as a (C8-C12)saturated fatty acid ester of a polyhydric alcohol, a (C12-C22)unsaturated fatty acid ester of a polyhydric alcohol, a (C8-C12)saturated fatty ether of a polyhydric alcohol, a (C12-C22)unsaturated fatty ether of a polyhydric alcohol, an alkoxylated derivative thereof, (C5-C12)1,2-saturated alkanediol, and (C12-C18)1,2-unsaturated alkanediol or combinations thereof (e.g., those described in U.S. Pub. No. 2005/0058673 (Scholz et al.)), peroxy acids (e.g., hydrogen peroxide, peracetic acid), and alcohols (e.g., ethyl alcohol, propyl alcohol).

In certain embodiments, the biocide is a compound capable of destroying or reducing the concentration of bacteria including Staphylococcus spp., Streptococcus spp., Escherichia spp., Enterococcus spp., Pseudamonas spp., or combinations thereof. In certain embodiments, the biocide is an antibacterial that destroys or reduces the concentration of Staphylococcus aureus, Staphylococcus epidermidis, Escherichia coli, Pseudomonas aeruginosa, Streptococcus pyogenes, or combinations thereof.

Various combinations of biocides can be used if desired.

### EXEMPLARY EMBODIMENTS

1. A composition of matter comprising:
   an aliphatic polyester;
   at least 2 wt-% of an unreacted epoxidized fatty ester, wherein the epoxidized fatty ester has greater than 4.7 wt-% oxirane oxygen, based on the total weight of the epoxidized fatty ester; and
   greater than 0 and up to 10 wt-% of a shrink reduction additive;
   wherein the aliphatic polyester, epoxidized fatty ester, and shrink reduction additive form a mixture; and
   wherein the weight percentages, other than the weight percentage of the oxirane oxygen, are based on the total weight of the mixture.
2. The composition of matter of embodiment 1 wherein the epoxidized fatty ester has at least 5.5 wt-% oxirane oxygen.
3. The composition of matter of embodiment 2 wherein the epoxidized fatty ester has at least 6 wt-% oxirane oxygen.
4. The composition of matter of embodiment 3 wherein the epoxidized fatty ester has at least 9 wt-% oxirane oxygen.
5. The composition of matter of any of embodiments 1 through 4 wherein the epoxidized fatty ester has up to 23 wt-% oxirane oxygen.
6. The composition of matter of any of embodiments 1 through 5 wherein the epoxidized fatty ester is an epoxidized poly(fatty ester).
7. The composition of matter of claim 6 wherein the epoxidized poly(fatty ester) is a triglyceride of an epoxidized polyunsaturated fatty acid derived from an unsaturated fatty acid selected from linoleic acid, linoelaidic acid, α-linolenic acid, arachidonic acid, eicosapentaenoic acid, docosahexaenoic acid, and combinations thereof.
8. The composition of matter of embodiment 6 wherein the epoxidized poly(fatty ester) is an epoxidized vegetable oil.
9. The composition of matter of embodiment 8 wherein the epoxidized vegetable oil is selected from the group of epoxidized soybean oil, epoxidized cottonseed oil, epoxidized wheat germ oil, epoxidized soya oil, epoxidized corn oil, epoxidized sunflower oil, epoxidized safflower oil, epoxidized hemp oil, epoxidized linseed oil, and combinations thereof.
10. The composition of matter of embodiment 9 wherein the epoxidized vegetable oil is derived from a vegetable oil having a polyunsaturated value of at least 60 grams per 100 grams total oil.
11. The composition of matter of any of embodiments 8 through 10 wherein the epoxidized vegetable oil comprises a di-ester, tri-ester, or combinations thereof.
12. The composition of matter of any of embodiments 1 through 11 wherein the epoxidized fatty ester is present in the mixture in an amount of up to 20 wt-%, based on the total weight of the mixture.
13. The composition of matter of embodiment 12 wherein the epoxidized fatty ester is present in the mixture in an amount of up to 10 wt-%, based on the total weight of the mixture.
14. The composition of matter of embodiment 13 wherein the epoxidized fatty ester is present in the mixture in an amount of up to 7 wt-%, based on the total weight of the mixture.
15. The composition of matter of any of embodiments 1 through 14 wherein the epoxidized fatty ester is present in the mixture in an amount of at least 3 wt-%, based on the total weight of the mixture.
16. The composition of matter of any of embodiments 1 through 15 wherein the aliphatic polyester is selected from the group of poly(lactide), poly(glycolide), poly(lactide-co-glycolide), poly(L-lactide-co-trimethylene carbonate), poly(dioxanone), poly(butylene succinate), poly(butylene adipate), poly(ethylene adipate), polyhydroxybutyrate, polyhydroxyvalerate, and blends and copolymers thereof.
17. The composition of matter of embodiment 16 wherein the aliphatic polyester is a poly(lactide).
18. The composition of matter of any of embodiments 1 through 17 wherein the aliphatic polyester has a number average molecular weight of at least 8,000 Daltons.
19. The composition of matter of embodiment 18 wherein the aliphatic polyester has a number average molecular weight of at least 10,000 Daltons.
20. The composition of matter of any of embodiments 18 or 19 wherein the aliphatic polyester has a number average molecular weight of up to 1,000,000 Daltons.
21. The composition of matter of any of embodiments 1 through 20 wherein the aliphatic polyester is present in an amount of at least 80 wt-%.
22. The composition of matter of any of embodiments 1 through 21 wherein the shrink reduction additive is a polyolefin.
23. The composition of matter of embodiment 22 wherein the polyolefin is selected from polyethylene, linear low density polyethylene, polypropylene, polyoxymethylene, poly(vinylidine fluoride), poly(methyl pentene), poly(ethylenechlorotrifluoroethylene), poly(vinyl fluoride), poly(ethylene oxide), poly(ethylene terephthalate), polybutylene terephthalate), semicrystalline aliphatic polyesters including polycaprolactone, aliphatic polyamides such as nylon 6 and nylon 66, and thermotropic liquid crystal polymers, and combinations thereof.
24. The composition of matter of embodiment 23 wherein the shrink reduction additive is a polypropylene.
25. The composition of matter of any of embodiments 1 through 24 which is in the form of a film.
26. The composition of matter of any of embodiments 1 through 24 which is in the form of fibers.
27. The composition of matter of embodiment 26 wherein the fibers form a nonwoven web.
28. A wet wipe comprising:
   a nonwoven web of embodiment 27; and
   an aqueous composition comprising water and a surfactant and/or a biocide (dissolved or dispersed in the water), wherein the aqueous composition is in contact with the nonwoven web.
29. A wet wipe comprising:
   a fibrous web comprising fibers comprising:
      an aliphatic polyester;
      at least 2 wt-% of an unreacted epoxidized fatty ester, wherein the epoxidized fatty ester has greater than 4.7 wt-% oxirane oxygen, based on the total weight of the epoxidized fatty ester; and
      greater than 0 and up to 10 wt-% of a shrink reduction additive (e.g., polyolefin);
      wherein the aliphatic polyester, epoxidized fatty ester, and shrink reduction additive form a mixture; and
      wherein the weight percentages, other than the weight percentage of the oxirane oxygen, are based on the total weight of the mixture; and
   an aqueous composition in contact with the fibrous web, the aqueous composition comprising:
      water; and
      a surfactant and/or a biocide (dissolved or dispersed in the water).
30. The wet wipe of embodiment 28 or 29 wherein the aqueous composition has a pH of 1 to 14.
31. The wet wipe of any of embodiments 28 through 30 wherein the aqueous composition comprises at least 0.01 wt-% surfactant and/or biocide, based on the total weight of the aqueous composition.
32. The wet wipe of any of embodiments 28 through 31 wherein the aqueous composition comprises a surfactant, wherein the wet wipe is a cleaning wipe.
33. The wet wipe of embodiment 32 wherein the surfactant comprises a nonionic surfactant.
34. The wet wipe of any of embodiments 28 through 31 wherein the aqueous composition comprises a biocide, wherein the wet wipe is a disinfecting wipe.
35. The wet wipe of any of embodiments 28 through 31 wherein the aqueous composition comprises a biocide and a surfactant, wherein the wet wipe is a cleaning/disinfecting wipe.
36. The wet wipe of any of embodiments 28 through 35 wherein the aqueous composition is present in an amount of at least 2 times the weight of the fibrous web.
37. A process for improving the hydrolytic stability of a composition of matter comprising an aliphatic polyester, the method comprising:
   mixing components comprising an aliphatic polyester, an unreacted epoxidized fatty ester, and a shrink reduction additive;
   wherein the shrink reduction additive is present in an amount of greater than 0 and up to 10 wt-%;
   wherein the epoxidized fatty ester is present in an amount of at least 2 wt-%, and has at least 4.7 wt-% oxirane oxygen, based on the total weight of the epoxidized fatty ester; and
   wherein the weight percentages, other than the weight percentage of the oxirane oxygen, are based on the total weight of the mixture.
38. The process of embodiment 37 further comprising forming fibers out of the mixture.
39. The process of embodiment 38 wherein forming fibers out of the mixture comprises forming spunbond fibers.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

### Materials

Unless otherwise noted, all parts, percentages, ratios, etc., in the examples and in the remainder of the specification are by weight. Unless otherwise noted, all chemicals were obtained from, or are available from, chemical suppliers such as Sigma-Aldrich Chemical Company, St. Louis, Mo.

NATUREWORKS PLA Polymer 6202D, (PLA) was poly(lactic acid), available from NatureWorks LLC, Minnetonka, Minn.

Polypropylene 3860X, (PP), was polypropylene homopolymer (melt index=100 grams/10 minutes) available from Total Petrochemicals, Houston, Tex.

PARAPLEX G-60, (G-60), was epoxidized soybean oil available from the HallStar Company, Chicago, Ill. PARAPLEX G-60, said to have 5.5% oxirane oxygen by manufacturer, was found to have 6.75% oxirane oxygen content when tested using the method described below.

STEROTEX NF, (ST-NF) was hydrogenated cottonseed oil (CAS No. 68334-00-9) available from Abitec, Columbus, Ohio.

VIKOFLEX 7170, (VK-7170) was epoxidized soybean oil (minimum oxirane oxygen content of 7.0% by manufacturer) available from Arkema Inc., King of Prussia, Pa. VIKOFLEX 7170, (VK-7170) was found to have 7.10% oxirane oxygen content when tested using the method described below.

VIKOFLEX 7190, (VK-7190) was epoxidized linseed oil (minimum oxirane oxygen content of 9.0% by manufacturer) available from Arkema Inc., King of Prussia, Pa.

PHBV is powdered poly(b-hydroxybutyrate-co-hydroxyvalerate) and is commercially available from Zhejiang Biological Materials Company, Zhejiang, China.

CAPMUL 908P, propylene glycol monocaprylate, available from Abitec Corporation, Columbus, Ohio.

GLUCOPON 425N, an alkyl polyglycoside surfactant available from BASF Chemical Company, Florham Park, N.J.

EASY WET 20, available from ISP Technologies Inc., Wayne, N.J.

DOW CORNING 7305 ANTIFOAM EMULSION, available from Dow Corning, Midland, Mich.

OMACIDE IPBC 30 DPG, a broad spectrum liquid fungicide based on the widely used fungicide active, 3-iodopropynylbutylcarbamate, available from Arch Chemical, Inc., Atlanta Ga.

CITRUS FRAGRANCE Number 70331, available from Belle-Aire Fragrances, Mundelin, Ill.

NAXOLATE AS-LG-85, sodium lauryl sulfate, available from Nease Corporation, Blue Ash, Ohio.

SOLUTION 1 was an aqueous (about 98.59 weight percent water) cleaning solution based on GLUCOPON 425N (1 weight percent) and EASY WET 20 (0.02 weight percent) DOW CORNING 7305 ANTIFOAM EMULSION (0.01 weight percent (wt-%)), dimethylol-5,5-dimethylhydantoin (0.2 weight percent), OMACIDE IPBC 30 DPG (0.03 weight percent), CITRUS FRAGRANCE Number 70331 (0.15 weight percent). The pH of the solution was 7.0.

SOLUTION 2 was an aqueous solution of Lonza LC-75, a quaternary ammonium compound based aqueous disinfectant solution (EPA Registration Number: 6836-334), available from Lonza Inc., Allendale, N.J. The Lonza LC-75 was diluted 1:75 with water to prepare Solution 2. The pH of this solution was 10.5.

SOLUTION 3 was an aqueous (about 97.73 weight percent water) disinfectant solution based on CAPMUL 908P, as active ingredient (0.24 weight percent) and, citric acid (0.3 weight percent), sorbic acid (0.3 weight percent), propylene glycol (0.81 weight percent), NAXOLATE AS-LG-85 (0.49 weight percent), sodium hydroxide (0.13 weight percent). The pH of the solution was 4.5.

### Test Methods

### Method for Determining % Shrinkage

Spunbond nonwoven webs produced as described below for Examples and Comparative Examples were tested for shrinkage. The width of the web sample before (W1) and after (W2) through-air bonding (TAB) was measured, and the % shrinkage (S) was calculated using the formula:

% Shrinkage (S)=(W1−W2)/W1*100

Also, the shrinkage reduction rate (SR) for PLA samples including additives (PLAA) with respect to pure PLA webs was calculated using the formula:

% Shrinkage Reduction (SR)=[S(PLA)−S(PLAA)]/S(PLA)*100

### Method for Tensile Strength and % Retention

Tensile strength measurements were made using a Lloyd LF Plus tensile tester (available from Lloyd Instruments, Segensworth Fareham England). The size of the spunbond nonwoven web samples that were tested was 1 inch (2.5 cm)×3 inch (7.62 cm) (width×length), and the gap for the tensile measurement was ⅛ inch (0.32 cm). Measurements were made in the direction of the length of the test samples unless indicated otherwise. The tensile strength in this experiment was defined as the maximum load when the nonwoven web was broken with 1 kg load, and was the average of 8 replicate nonwoven web samples. The % tensile strength retention (i.e., % retention) was calculated by dividing the tensile strength after aging in a disinfecting solution by the initial tensile strength and multiplying by 100.

### Method for Measuring % Extension

% extension for the Example and Comparative Example nonwoven webs were determined during the tensile strength measurements using the formula:

% Extension=(extension at maximum load*7.62)/100

Method for Preparing Spunbond Nonwoven Web of PLA and PLA with Additives

First, compounded pellets of PLA with additives such as epoxidized vegetable oil (EVO), including for example epoxidized soybean oil, and polypropylene (PP), were produced using a 40 mm twin-screw extruder (Berstorff Ultra Glide laboratory extruder available from KraussMaffei Berstorff GmbH, Germany) by mixing pre-dried PLA resin with the additive at a melt temperature of 368-371° F. (187-188° C.) and then extruding at a rate of 60 lb/hour (27 kg/hour). The pre-drying of the PLA resin was accomplished in a Conair dryer with 130° F. (55° C.) hot air at the flow rate of 45-55 cubic feet per minute (CFM) (1275-1550 liters per minute), dew point −34° F. (−37° C.) for 15 hours. The compounded material was quenched in a water bath and pelletized using a Conair Model 304 Pelletizer available from Conair USA, Franklin, Pa. The pellets were then immediately dried overnight in a Conair dryer at 170° F. (77° C.) with a dry air flow rate of 45-55 CFM (1275-1550 liters per minute) and dew point of −34° F. (−37° C.).

Spunbond nonwoven webs according to the Examples and Comparative Examples described below were made from PLA pellets and the compounded PLA/additive pellets prepared as described above. The PLA spunbond nonwoven webs were prepared on an experimental spunbond line using the equipment and processing techniques for spunbond nonwoven webs described in U.S. Patent Publication No. 2008/0038976 (Berrigan et al.). Typically, the PLA pellets prepared above were fed from a hopper into a 2 inch (5 cm) single screw extruder (Davis-Standard BLUE RIBBON (DS-20) available from Davis Standard Corporation, Pawcatuck, Conn.). The extruder temperature was 230° C. The molten resin was pumped via a gear pump into a spin pack having rows of small orifices. The orifices, arranged in a rectangular form, had a diameter of 0.014 inch (0.36 mm) and a length to diameter ratio (L/D) of 4. Fibers were formed through the spin pack and subsequently cooled down by passing them through a quenching air chamber. The rate and extent of fiber attenuation was controlled by the attenuating pressure (AP) of the attenuator air—the higher the attenuating pressure, the faster and greater the extent of attenuation. The attenuated PLA fibers were collected as an unbonded fiber mat on a conventional screen support using vacuum assistance, and the fiber mat was then passed through a through-air bonder (TAB) at a temperature of 147° C. in order to cause light autogenous bonding between at least some of the fibers. The web was subsequently treated by a typical hydroentangling/spunlacing process and then dried. This further bonded the fibers in the web and provided web softness.

### Method for Preparing Wet Wipes Using the PLA Spunbond Nonwoven Webs for Aging Studies

The PLA spunbond nonwoven webs prepared as described above were cut into 6 inch×5 inch (15.2 cm×12.7 cm) samples, and an excess of the cleaning/disinfecting solution to be used for testing was loaded onto the webs (generally about six times the web weight). The loaded wipes were then sealed in aluminum bags and aged in an oven at maintained at either 135° F. or 158° F. (57° C. or 70° C.) over a period of time as indicated in the examples. After removing the webs from the oven, excess cleaning solution was squeezed from the webs by passing the webs between nip rollers. The hydrolytic stability of the PLA spunbond nonwoven webs was then assessed by measuring the tensile strength of the aged PLA spunbond nonwoven webs and comparing the data to the tensile strength data that was measured for PLA spunbond nonwoven webs that had not been aged.

### Method for Determining Epoxy Equivalent Weight (EEW) and % Oxirane Oxygen Content

The epoxy equivalent weight of the samples was measured and calculated using titrimetry according to the following procedure. Each sample (about 0.5-0.9 milliequivalents epoxy) was weighed to the nearest 0.0001 gram and was then dissolved in 50 mL chloroform in a 100 mL beaker and stirred magnetically until dissolved. A solution of 10 weight percent tetrabutylammonium iodide in acetic acid (10 mL) and acetic acid (20 mL) was added to the sample solution and stirred for approximately 15 minutes. A drop of 0.1 weight percent methyl violet indicator solution in acetic acid was then added. The mixture was titrated with a 0.1 N solution of perchloric acid in acetic acid to the potentiometric endpoint. The potentiometer was a Metrohm 751 Titrino with a Metrohm 6.0229.010 Solvotrode electrode that was obtained from Metrom AG, Switzerland. A blank was titrated using the sample procedure without the sample aliquot. The volume for the blank titration was subtracted from the total titration volume from the above procedure. Samples were run in triplicate.

Calculations were performed as shown below:

% Epoxy containing compound=[100(V)(N)(Eq. Wt.)]÷[1000(SW)]

Epoxy Equivalent Weight (EEW)=[1000(SW)]÷[(V)(N)]

% oxirane content=[1600(V)(N)]÷[1000(SW)]

where V is the Volume of titrant used in milliliters, N is the Normality of the titrant, SW is the Sample Weight in grams, and Eq. Wt. is the Equivalent Weight. The Equivalent Weight is the Molecular Weight of the epoxy containing compound in grams divided by the number of equivalents per gram.

### Examples 1-3 Ex1-Ex3) and Comparative Examples 1-11 (Ce1-Ce11

EX1-EX3 and CE1-CE11 webs were prepared using the methods described above for preparing spunbond nonwoven web of PLA and PLA with additives. Table 1, below, describes the formulation (i.e., the type and amounts of additives) and the attenuation pressure for each of EX1-EX3 and CE1-CE11.

TABLE 1

| | Wt % | Type | Wt % | Wt. % | AP |
|---|---|---|---|---|---|
| Example | of PLA | of EVO | of EVO | PP | (psi) |
| CE1 | 100 | N/A | 0 | 0 | 9 |
| CE2 | 98 | N/A | 0 | 2 | 9 |
| CE3 | 95 | G-60 | 5 | 0 | 9 |
| CE4 | 95 | G-60 | 5 | 0 | 15 |
| CE5 | 100 | N/A | 0 | 0 | 12 |
| CE6 | 99 | ST-NF | 1 | 0 | 12 |
| CE7 | 99 | G-60 | 1 | 0 | 12 |
| CE8 | 97.5 | G-60 | 2.5 | 0 | 12 |
| CE9 | 95 | G-60 | 5 | 0 | 12 |
| CE10 | 95 | VK-7170 | 5 | 0 | 12 |
| CE11 | 95 | VK-7190 | 5 | 0 | 12 |
| EX1 | 95 | G-60 | 3 | 2 | 9 |
| EX2 | 95 | G-60 | 3 | 2 | 15 |
| EX3 | 95 | G-60 | 3 | 2 | 12 |

N/A means not added

CE1-CE4 and EX1-EX2 nonwoven webs were tested to determine their % shrinkage (S) and shrinkage reduction rate (SR). The results of the test are summarized in Table 2, below. Note that the SR for EX1 sample was determined with respect to the CE3 sample rather than CE1.

TABLE 2

| | W1 | W2 | | |
|---|---|---|---|---|
| Example | (inch) | (inch) | S | SR |
| CE1 | 27 | 19 | 29.6% | Control |
| CE2 | 26 | 20 | 23.1% | 21.95% |
| CE3 | 27 | 17 | 37.0% | −25.0% |
| CE3 | 27 | 17 | 37.0% | Control for EX1 |
| EX1 | 26 | 18.5 | 28.8% | 22.16% |
| CE4 | 25 | 18 | 28.0% | Control for EX2 |
| EX2 | 25 | 19 | 24.0% | 14.28% |

Wet wipes were prepared from the nonwoven webs of CE1-CE2 and EX1 and SOLUTION 1 using the method described above. The wet wipes were aged in sealed aluminum bags at 135° F. (57° C.). During aging, the samples were tested for their tensile strength and the % retention using the methods described above at predetermined intervals. The results of the test are summarized in Table 3, below.

TABLE 3

| | Example | | | | | |
|---|---|---|---|---|---|---|
| | CE1 | | CE2 | | EX1 | |
| | Tensile | % | Tensile | % | Tensile | % |
| Aging | Strength | Reten- | Strength | Reten- | Strength | Reten- |
| (days) | (kgf) | tion | (kgf) | tion | (kgf) | tion |
| 0 | 6.9205 | 100 | 8.2054 | 100 | 7.0737 | 100 |
| 8 | 5.0113 | 72 | 5.1284 | 63 | 4.0916 | 58 |
| 14 | 6.2121 | 90 | 7.0850 | 86 | 5.9883 | 85 |
| 22 | 4.6225 | 67 | 5.0108 | 61 | 3.7744 | 53 |
| 27 | 3.5430 | 51 | 3.7402 | 46 | 4.2276 | 60 |
| 29 | 2.6394 | 38 | 2.7509 | 34 | 3.5182 | 50 |
| 31 | 1.6919 | 24 | 1.9602 | 24 | 3.6775 | 52 |
| 33 | 0.9465 | 14 | 1.2028 | 15 | 3.1348 | 44 |
| 35 | 0.3918 | 6 | 0.5746 | 7 | 2.0762 | 29 |
| 37 | | | | | 2.2730 | 32 |

The above experiment was repeated except that the wet wipes were aged at 158° F. (70° C.). The results of the test are summarized in Table 4, below.

TABLE 4

| | CE1 | | CE2 | | EX1 | |
|---|---|---|---|---|---|---|
| | Tensile | % | Tensile | % | Tensile | % |
| Aging | Strength | Reten- | Strength | Reten- | Strength | Reten- |
| (Days) | (kgf) | tion | (kgf) | tion | (kgf) | tion |
| 0 | 6.920 | 100 | 8.205 | 100 | 7.074 | 100 |
| 1 | 6.661 | 96 | 7.025 | 86 | 5.693 | 80 |
| 2 | 5.740 | 83 | 7.114 | 87 | 6.261 | 89 |
| 3 | 5.647 | 82 | 5.861 | 71 | 5.923 | 84 |
| 4 | 4.922 | 71 | 5.172 | 63 | 4.156 | 59 |
| 5 | 3.952 | 57 | 4.510 | 55 | 3.888 | 55 |
| 6 | 1.922 | 28 | 2.741 | 33 | 2.834 | 40 |
| 7 | 0.437 | 6 | 0.737 | 9 | 1.949 | 28 |
| 8 | | | | | 0.485 | 7 |

Wet wipes were prepared from the nonwoven webs of CE5-CE11 and EX3 and SOLUTION 1 using the method described above. The wet wipes were aged in sealed aluminum bags at 158° F. (70° C.). During aging, the samples were tested for their tensile strength and the % retention using the methods described above at predetermined intervals. The results of the tensile strength (kgf) and % retention test data are summarized in Tables 5 and 5a, respectively.

TABLE 5

| Aging | | | | | | | | |
|---|---|---|---|---|---|---|---|---|
| (days) | CE5 | CE6 | CE7 | CE8 | CE9 | EX3 | CE10 | CE11 |
| 0 | 8.2331 | 11.2745 | 8.8178 | 9.4199 | 7.0998 | 8.0981 | 9.7044 | 9.1883 |
| 1 | 6.8185 | 7.5194 | 7.0286 | 7.9318 | 6.2714 | 6.4000 | 8.0252 | 7.6913 |
| 2 | 6.5168 | 7.7490 | 7.0710 | 7.0381 | 5.8508 | 6.1186 | 7.7284 | 7.7978 |
| 3 | 6.1411 | 7.7817 | 6.7535 | 5.7406 | 5.6909 | 6.3546 | 6.1731 | 7.5299 |
| 4 | 5.2758 | 5.4731 | 6.5269 | 4.9829 | 5.4677 | 5.5854 | 6.4471 | 6.5388 |
| 5 | 3.9583 | 3.8225 | 5.4617 | 4.0798 | 4.8829 | 4.9905 | 5.0749 | 5.4572 |
| 6 | 1.9964 | 1.9671 | 3.4406 | 1.7643 | 3.5170 | 3.2978 | 3.9304 | 6.1711 |
| 7 | 0.3093 | 0 | 1.5397 | 0.9959 | 2.0981 | 2.4209 | 2.5223 | 4.5418 |
| 8 | | | 0.4048 | 0.4145 | 1.5740 | 0.6825 | 1.5692 | 3.9213 |

TABLE 5a

| Aging | | | | | | | | |
|---|---|---|---|---|---|---|---|---|
| (days) | CE5 | CE6 | CE7 | CE8 | CE9 | EX3 | CE10 | CE11 |
| 0 | 100 | 100 | 100 | 100 | 100 | 100 | 100 | 100 |
| 1 | 83 | 67 | 80 | 84 | 88 | 79 | 83 | 84 |
| 2 | 79 | 69 | 80 | 75 | 82 | 76 | 80 | 85 |
| 3 | 75 | 69 | 77 | 61 | 80 | 78 | 64 | 82 |
| 4 | 64 | 49 | 74 | 53 | 77 | 69 | 66 | 71 |
| 5 | 48 | 34 | 62 | 43 | 69 | 62 | 52 | 59 |
| 6 | 24 | 17 | 39 | 19 | 50 | 41 | 41 | 67 |
| 7 | 4 | 0 | 17 | 11 | 30 | 30 | 26 | 49 |
| 8 | | | 5 | 4 | 22 | 8 | 16 | 43 |

Wet wipes were prepared from the nonwoven webs of CE5-CE11 and EX3 and SOLUTION 2 using the method described above. The wet wipes were aged in sealed aluminum bags at 158° F. (70° C.). During aging, the samples were tested for their tensile strength and the % retention using the methods described above at predetermined intervals. The results of the tensile strength (kgf) and % retention test data are summarized in Tables 6 and 6a, respectively.

TABLE 6

| Aging | | | | | | | | |
|---|---|---|---|---|---|---|---|---|
| (days) | CE5 | CE6 | CE7 | CE8 | CE9 | EX3 | CE10 | CE11 |
| 0 | 8.1650 | 9.3456 | 9.1263 | 9.6192 | 7.5406 | 7.4859 | 10.6996 | 9.5319 |
| 1 | 7.2035 | 9.4574 | 6.7291 | 8.1437 | 5.7979 | 6.2959 | 8.3712 | 8.2149 |
| 2 | 6.2132 | 7.5551 | 6.2616 | 6.0255 | 4.9008 | 5.9652 | 7.3545 | 7.2061 |
| 3 | 3.5920 | 4.3875 | 4.8195 | 3.5594 | 3.4573 | 4.6225 | 5.8772 | 6.4496 |
| 4 | 1.7399 | 1.5399 | 2.0234 | 1.3148 | 1.7868 | 2.3173 | 3.4993 | 5.4484 |
| 5 | 0.7926 | 0.8746 | 0.6919 | 0.3833 | 0.8505 | 0.5354 | 2.0875 | 5.0001 |
| 6 | 0.2434 | 0.2047 | 0 | 0 | 0 | 0 | 0.2793 | 4.3053 |
| 7 | 0 | 0 | | | | | 0 | 2.6215 |
| 8 | | | | | | | | 1.6567 |

TABLE 6a

| Aging | | | | | | | | |
|---|---|---|---|---|---|---|---|---|
| (days) | CE5 | CE6 | CE7 | CE8 | CE9 | EX3 | CE10 | CE11 |
| 0 | 100 | 100 | 100 | 100 | 100 | 100 | 100 | 100 |
| 1 | 88 | 101 | 74 | 85 | 77 | 84 | 78 | 86 |
| 2 | 76 | 81 | 69 | 63 | 65 | 80 | 69 | 76 |
| 3 | 44 | 47 | 53 | 37 | 46 | 62 | 55 | 68 |
| 4 | 21 | 16 | 22 | 14 | 24 | 31 | 33 | 57 |
| 5 | 10 | 9 | 8 | 4 | 11 | 7 | 20 | 52 |
| 6 | 3 | 2 | 0 | 0 | 0 | 0 | 3 | 45 |
| 7 | | | | | | | 0 | 28 |
| 8 | | | | | | | | 17 |

Wet wipes were prepared from the nonwoven webs of CE5-CE11 and EX3 and SOLUTION 3 using the method described above. The wet wipes were aged in sealed aluminum bags at 158° F. (70° C.). During aging, the samples were tested for their tensile strength and the % retention using the methods described above at predetermined intervals. The results of the tensile strength (kgf) and % retention test data are summarized in Tables 7 and 7a, respectively.

TABLE 7

| Aging | | | | | | | | |
|---|---|---|---|---|---|---|---|---|
| (days) | CE5 | CE6 | CE7 | CE8 | CE9 | EX3 | CE10 | CE11 |
| 0 | 7.6367 | 10.3987 | 8.6853 | 9.3095 | 6.8746 | 7.0444 | 9.4467 | 8.8587 |
| 1 | 5.6313 | 6.2917 | 6.4398 | 4.8851 | 4.6559 | 5.3047 | 6.2299 | 6.4630 |
| 2 | 3.2372 | 4.3848 | 4.3056 | 2.8435 | 3.0478 | 3.8243 | 5.0349 | 5.1382 |
| 3 | 0.991 | 0.4582 | 1.5940 | 0.8559 | 1.2322 | 1.2373 | 2.1050 | 3.0362 |
| 4 | 0 | 0 | 0 | 0 | 0 | 0 | 0.4035 | 0.7673 |
| 5 | | | | | | | | 0.2890 |

TABLE 7a

| Aging | | | | | | | | |
|---|---|---|---|---|---|---|---|---|
| (days) | CE5 | CE6 | CE7 | CE8 | CE9 | EX3 | CE10 | CE11 |
| 0 | 100 | 100 | 100 | 100 | 100 | 100 | 100 | 100 |
| 1 | 74 | 61 | 74 | 52 | 68 | 75 | 66 | 73 |
| 2 | 42 | 42 | 50 | 31 | 44 | 54 | 53 | 58 |
| 3 | 13 | 4 | 18 | 9 | 18 | 18 | 22 | 34 |
| 4 | 0 | 0 | 0 | 0 | 0 | 0 | 4 | 9 |
| 5 | | | | | | | | 3 |

Wet wipes were prepared from the nonwoven webs of CE5-CE11 and EX3 and SOLUTION 3 using the method described above. The wet wipes were aged in sealed aluminum bags at 135° F. (57° C.). During aging, the samples were tested for their tensile strength and the % retention using the methods described above at predetermined intervals. The results of the tensile strength (kgf) and % retention test data are summarized in Tables 8 and 8a, respectively.

TABLE 8

| Aging | | | | | | | | |
|---|---|---|---|---|---|---|---|---|
| (days) | CE5 | CE6 | CE7 | CE8 | CE9 | EX3 | CE10 | CE11 |
| 0 | 8.2331 | 11.2745 | 8.8178 | 9.4199 | 7.0998 | 8.0981 | 9.7044 | 9.1883 |
| 8 | 5.5468 | 7.0834 | 5.6777 | 4.976 | 4.4179 | 4.8777 | 5.7111 | 6.2569 |
| 14 | 6.4216 | 7.0777 | 6.9265 | 6.7929 | 6.2217 | 5.8718 | 7.7305 | 7.5209 |
| 22 | 4.6507 | 5.2732 | 5.9683 | 4.8838 | 4.4071 | 4.2857 | 6.1349 | 6.2414 |
| 27 | 2.8418 | 3.6124 | 5.0892 | 4.0796 | 4.1873 | 4.6049 | 6.5289 | 7.0018 |
| 29 | 1.9688 | 2.0871 | 4.1232 | 2.862 | 4.5447 | 4.4078 | 5.8967 | 6.7105 |
| 31 | 1.3527 | 1.409 | 3.1741 | 2.5956 | 3.7585 | 3.9896 | 5.3636 | 6.5718 |
| 33 | 0.8745 | 0.7697 | 2.8646 | 2.0837 | 3.5784 | 3.5312 | 5.6155 | 6.2926 |
| 35 | 0.2322 | 0.2221 | 2.0093 | 1.1335 | 3.0139 | 2.5020 | 4.585 | 5.6353 |
| 37 | | | 1.1643 | 1.1476 | 2.5453 | 2.5445 | 4.8547 | 6.3735 |

TABLE 8a

| Aging | | | | | | | | |
|---|---|---|---|---|---|---|---|---|
| (days) | CE5 | CE6 | CE7 | CE8 | CE9 | EX3 | CE10 | CE11 |
| 0 | 100 | 100 | 100 | 100 | 100 | 100 | 100 | 100 |
| 8 | 67 | 63 | 64 | 53 | 62 | 60 | 59 | 68 |
| 14 | 78 | 63 | 79 | 72 | 88 | 73 | 80 | 82 |
| 22 | 56 | 47 | 68 | 52 | 62 | 53 | 63 | 68 |
| 27 | 35 | 32 | 58 | 43 | 59 | 57 | 67 | 76 |
| 29 | 24 | 19 | 47 | 30 | 64 | 54 | 61 | 73 |
| 31 | 16 | 12 | 36 | 28 | 53 | 49 | 55 | 72 |
| 33 | 11 | 7 | 32 | 22 | 50 | 44 | 58 | 68 |
| 35 | 3 | 2 | 23 | 12 | 42 | 31 | 47 | 61 |
| 37 | | | 13 | 12 | 36 | 31 | 50 | 69 |

### Example 4 (Ex4)

The EX4 is prepared in the same manner as EX3 except that the spunbond nonwoven web of PLA containing G-60 and PP is replaced with spunbond nonwoven web of PHBV containing G-60 and PP additives. Spunbond nonwoven web of PHBV containing G-60 and PP additives is prepared using the method described above for preparing spunbond nonwoven web of PLA and PLA with additives in the same manner.

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

What is claimed is:

1. A composition of matter comprising:
an aliphatic polyester;
at least 2 wt-% of an unreacted epoxidized fatty ester, wherein the epoxidized fatty ester has greater than 4.7 wt-% oxirane oxygen, based on the total weight of the epoxidized fatty ester; and
greater than 0 and up to 10 wt-% of a shrink reduction additive;
wherein the aliphatic polyester, epoxidized fatty ester, and shrink reduction additive form a mixture; and
wherein the weight percentages, other than the weight percentage of the oxirane oxygen, are based on the total weight of the mixture.

2. The composition of matter of claim 1 wherein the epoxidized fatty ester has at least 5.5 wt-% oxirane oxygen.

3. The composition of matter of claim 1 wherein the epoxidized fatty ester has up to 23 wt-% oxirane oxygen.

4. The composition of matter of claim 1 wherein the epoxidized fatty ester is an epoxidized poly(fatty ester).

5. The composition of matter of claim 1 wherein the epoxidized fatty ester is present in the mixture in an amount of up to 20 wt-%, based on the total weight of the mixture.

6. The composition of matter of claim 1 wherein the epoxidized fatty ester is present in the mixture in an amount of at least 3 wt-%, based on the total weight of the mixture.

7. The composition of matter of claim 1 wherein the aliphatic polyester is selected from the group of poly(lactide), poly(glycolide), poly(lactide-co-glycolide), poly(L-lactide-co-trimethylene carbonate), poly(dioxanone), poly(butylene succinate), poly(butylene adipate), poly(ethylene adipate), polyhydroxybutyrate, polyhydroxyvalerate, and blends and copolymers thereof.

8. The composition of matter of claim 7 wherein the aliphatic polyester is a poly(lactide).

9. The composition of matter of claim 1 wherein the aliphatic polyester has a number average molecular weight of at least 8,000 Daltons.

10. The composition of matter of claim 1 wherein the aliphatic polyester is present in an amount of at least 80 wt-%.

11. The composition of matter of claim 1 wherein the shrink reduction additive is a polyolefin.

12. The composition of matter of claim 1 which is in the form of a film.

13. The composition of matter of claim 1 which is in the form of fibers.

14. The composition of matter of claim 13 wherein the fibers form a nonwoven web.

15. A wet wipe comprising:
a nonwoven web of claim 14; and
an aqueous composition comprising water and a surfactant and/or a biocide, wherein the aqueous composition contacts the nonwoven web.

16. A wet wipe comprising:
a fibrous web comprising fibers comprising:
an aliphatic polyester;
at least 2 wt-% of an unreacted epoxidized fatty ester, wherein the epoxidized fatty ester has greater than 4.7 wt-% oxirane oxygen, based on the total weight of the epoxidized fatty ester; and
greater than 0 and up to 10 wt-% of a shrink reduction additive;
wherein the aliphatic polyester, epoxidized fatty ester, and shrink reduction additive form a mixture; and
wherein the weight percentages, other than the weight percentage of the oxirane oxygen, are based on the total weight of the mixture; and
an aqueous composition contacting the fibrous web, the aqueous composition comprising:
water; and
a surfactant and/or a biocide.

17. The wet wipe of claim 16 wherein the aqueous composition comprises a surfactant, wherein the wet wipe is a cleaning wipe.

18. The wet wipe of claim 16 wherein the aqueous composition comprises a biocide, wherein the wet wipe is a disinfecting wipe.

19. The wet wipe of claim 16 wherein the aqueous composition comprises a biocide and a surfactant, wherein the wet wipe is a cleaning/disinfecting wipe.

20. A process for improving the hydrolytic stability of a composition of matter comprising an aliphatic polyester, the method comprising:
mixing components comprising an aliphatic polyester, an unreacted epoxidized fatty ester, and a shrink reduction additive;
wherein the shrink reduction additive is present in an amount of greater than 0 and up to 10 wt-%;
wherein the epoxidized fatty ester is present in an amount of at least 2 wt-%, and has at least 4.7 wt-% oxirane oxygen, based on the total weight of the epoxidized fatty ester; and
wherein the weight percentages, other than the weight percentage of the oxirane oxygen, are based on the total weight of the mixture.
